(19) United States
(12) Patent Application Publication
(10) Pub. No.: US 2016/0019411 A1
(43) Pub. Date: Jan. 21, 2016

(54) Computer-Implemented System And Method For Personality Analysis Based On Social Network Images

(71) Applicant: Palo Alto Research Center Incorporated, Palo Alto, CA (US)

(72) Inventors: Evgeniy Bart, Santa Clara, CA (US); Arijit Biswas, Kolkata (IN)

(21) Appl. No.: 14/332,228

(22) Filed: Jul. 15, 2014

(51) Int. Cl. G06K 9/00; H04L 29/08; G06K 9/62; H04L 29/06

(52) U.S. Cl. CPC G06K 9/00221; H04L 65/403; H04L 67/306; G06K 9/00228; G06K 9/00268; G06K 9/6218

(57) ABSTRACT

A computer-implemented system and method for personality analysis based on social network images are provided. A plurality of images posted to one or more social networking sites by a member of these sites are accessed. An analysis of the images is performed. Personality of the member is evaluated based on the analysis of the images.

### FIELD

This application relates in general to personality analysis, and in particular, to a computer-implemented system and method for personality analysis based on social network images.

### BACKGROUND

Knowledge of personality traits of individuals can be valuable in many contexts. For example, for organizations, regardless of whether they are business entities, educational institutions, or governmental units, such knowledge can be useful to improve workplace compatibility, reduce conflicts, and detect anomalous or malicious behavior. Similarly, such knowledge may be useful in a medical context, such as for monitoring effects of a treatment on the psychological wellbeing of a patient, detecting depression, and preventing suicide.

Obtaining this knowledge about individuals can be difficult as people may not be willing to provide unbiased information about themselves to interested parties, such as a potential employer. Furthermore, this challenge is exacerbated when a large number of individuals of interest is involved and the information about the personality of each of the individuals needs to be kept up-to-date. Whereas for an evaluation by a trained psychologist may be conducted for a small number of individuals, such an evaluation becomes impractical as the number of individuals grows and there is a need for reevaluations.

Current technology does not provide an efficient and accurate way to deal with these challenges. For example, currently one way a personality of a person is evaluated is by making the subject of the evaluation fill out specifically-designed surveys. Such surveys tend to be time-consuming and potentially intrusive, discouraging the individuals from thoroughly and completely answering the questions of the surveys. Furthermore, such surveys provide information about an individual's personality only at the time the survey is taken; detecting any changes in the individual's personality would require an individual to take the survey again, which is impracticable. Finally, the results of such surveys may be subject to manipulation, with the individuals answering the survey having the opportunity to misrepresent information about themselves in the answers.

Therefore, there is a need for an objective and efficient way to evaluate personality traits of a large number of individuals and detect changes in the individuals' personality over time.

### SUMMARY

An analysis of images that a person posts on his or her social networking pages provide clues towards the person's personality. The individuals appearing in the images, the scenes in the images, and the objects in the images can be analyzed and a trained supervised machine learning algorithm can perform an evaluation of the person's personality based on the analysis of the images. Such an evaluation does not require a direct input from the person whose personality is evaluated, allowing evaluations of multiple people to be conducted simultaneously, easily repeating an evaluation at a later point of time, and reducing the possibility that a person can influence the evaluation through misrepresentations. The efficiency of the evaluations makes the evaluation easily applicable to a multitude of areas, such as monitoring well-being of individuals, detecting malicious insiders, and advertising products or services best-suited for a person's personality.

In one embodiment, a computer-implemented system and method for personality analysis based on social network images are provided. A plurality of images posted to one or more social networking sites by a member of these sites are accessed. An analysis of the images is performed. Personality of the member is evaluated based on the analysis of the images.

Still other embodiments of the present invention will become readily apparent to those skilled in the art from the following detailed description, wherein is described embodiments of the invention by way of illustrating the best mode contemplated for carrying out the invention. As will be realized, the invention is capable of other and different embodiments and its several details are capable of modifications in various obvious respects, all without departing from the spirit and the scope of the present invention. Accordingly, the drawings and detailed description are to be regarded as illustrative in nature and not as restrictive.

### BRIEF DESCRIPTION OF THE DRAWINGS

FIG. 1 is a block diagram showing a system for personality analysis based on social network images in accordance with one embodiment.

FIG. 2 is a flow diagram showing a computer-implemented method for personality analysis based on social network images in accordance with one embodiment.

FIG. 3 is a flow diagram showing a routine for analyzing faces in the images for use in the method of FIG. 2 in accordance with one embodiment.

FIG. 4 is a flow diagram showing a routine for analyzing scenes present in the images for use in the method of FIG. 2 in accordance with one embodiment.

FIG. 5 is a flow diagram showing a routine for analyzing objects present in the images for use in the method of FIG. 2 in accordance with one embodiment.

FIG. 6 is a flow diagram showing a routine for evaluating personality of a social network member by a supervised machine learning algorithm based on analyzed images for use in the method of FIG. 2 in accordance with one embodiment.

### DETAILED DESCRIPTION

An individual's personality can be described using one or more personality models, with each model being a description of an individual's personality using one or more traits. For example, the Five Factor model, also known as the “Big Five” factors model defines five broad factors, or dimensions, of personality: openness to experience, conscientiousness, extraversion, agreeableness, and neuroticism. Each of these factors is a cluster of particular personality traits. For example, extraversion is a cluster of traits such as assertiveness, excitement seeking, and gregariousness. An assessment of an individual's personality using the model includes calculating a score for each of the five factors, with the score for each of the factors representing the strength the traits clustered under that factor in the member's personality. While personality models such as the Five Factor model aim for a comprehensive assessment of a member's personality, other models can describe specific aspects of a person's personality, such as how strong the person's family ties are, whether the person likes sports, and what kind of activities the person likes to engage in. These models can be quantitative, such as including a score that indicates the strength of a particular trait in a person, or binary, such as whether a user has a particular trait, such as a liking for football, or not.

While there are a multiple ways to evaluate a user's personality, images that a person posts on social networking sites of which he or she is a member are an excellent source of clues towards that member's personality, and can be used to evaluate the member's personality based on one or more personality models. For instance, a member posting photographs with his wife and children is a clue to the member being attached to his family. On the other hand, a member posting photographs of being in a pub along with his friends can be a clue that the member likes to socialize and is not yet married. Processing these pictures allows to evaluate the member's personality. As the processing of the images does not require member input, an analysis of personalities of multiple members can be performed efficiently and repeated as often as necessary. Furthermore, the lack of direct member input in the analysis reduces the likelihood of intentional manipulation of the evaluation results by members. In addition, as many people like to document almost every day of their life on a social networking site, the social networking sites can provide a wealth of detail regarding the person's life.

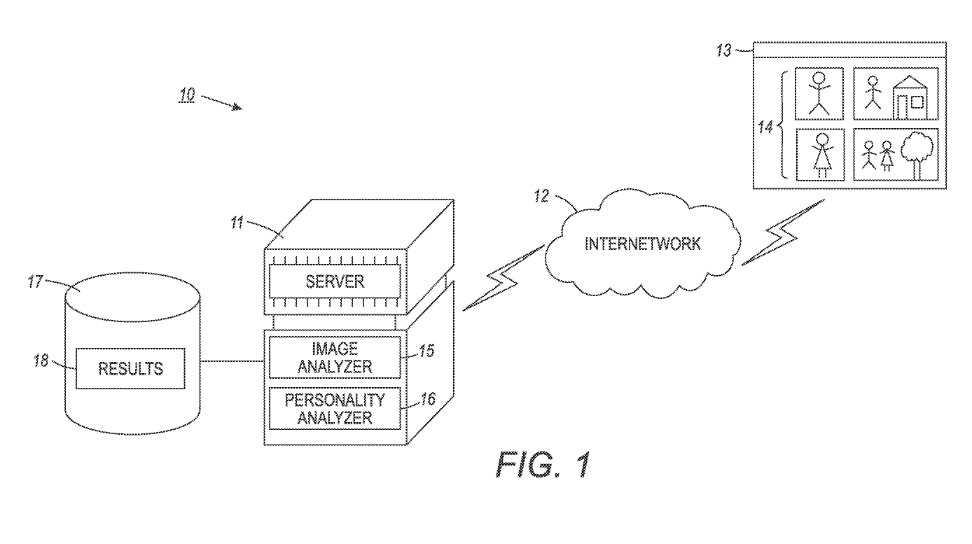

FIG. 1 is a block diagram showing a system 10 for personality analysis based on social network images in accordance with one embodiment. The system includes at least one server 11 that is connected to an Internetwork 12, such as the Internet. The server 11 can connect to one or more social networking sites 13 over the Internetwork 12 and access images 14, such as photographs, posted by a member of the social networking sites 13. The social networking sites 13 can include any Internet sites that enable members to communicate with each other by posting member-generated content such as comments, messages, and images 14. Examples of social networking sites 13 include Facebook®, My Space®, Twitter®, Pinterest®, though other examples of social networking sites 13 are possible.

In one embodiment, the server 11 accesses publicly-available images 14;

in a further embodiment, the server 11 receives from the member access to all of the images 14 stored on the sites 13.

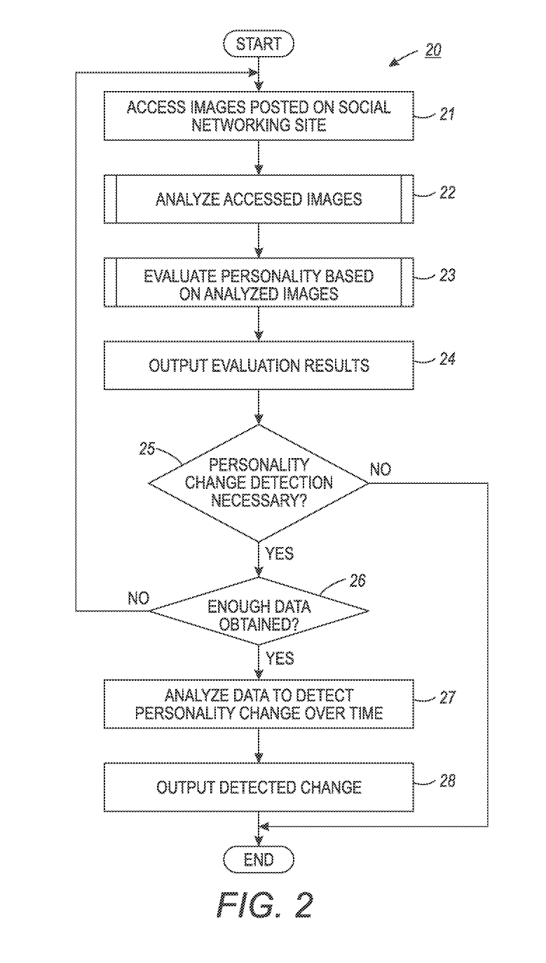

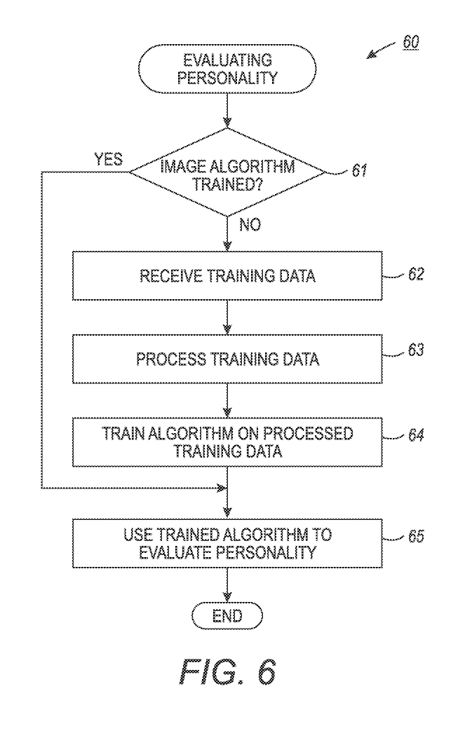

The server 11 implements an image analyzer program 15 that can analyze images 14 accessed from the social networking sites 13 and evaluate the member's personality based on the analyzed images, as further described below beginning with reference to FIG. 2. The analysis of the images 14 can include analyzing faces of individuals, scenes, and objects present in the images 14. Other attributes of the images 14 besides the faces, scenes, and the objects, can also be analyzed. A scene can be any location present in the images 14. For example, a scene can be an office, a home, a kitchen, a sea, a mountain, a river, a street, a bookshop, a coffee shop, etc. Other kinds of scenes are possible. The objects can be any living entity other than humans present in the image, such as animals, or non-living entity, such as bottles of beer, a bed, or a bookshelf present in the images 14. The server 11 further includes a personality analyzer program 16, which uses the analyzed images 14 to evaluate the personality of the member who posted the images 14, as further described beginning with reference to FIG. 2. The personality analyzer program 16 runs a supervised machine learning algorithm that has been previously trained to evaluate personality based on social networking images 14, as further described below beginning with reference to FIG. 6. The personality of the member can be evaluated in accordance with one or more psychological models, such as the Five Factor model, though other psychological models can also be used.

The server 11 is further connected to a database 17 that can store results of the personality evaluations 18 performed by the server 11. Other data can also be stored in the database 17. For example, the accessed images 14 can be downloaded by the server 11 and stored in the database 17. Still other data can be stored in the database 17.

The server 11 can include components conventionally found in general purpose programmable computing devices, such as a central processing unit, memory, input/output ports, network interfaces, and non-volatile storage, although other components are possible. The central processing unit can implement computer-executable code, such as the image analyzer program 15 and the personality analyzer program 16, which can be implemented as modules. The modules can be implemented as a computer program or procedure written as source code in a conventional programming language and presented for execution by the central processing unit as object or byte code. Alternatively, the modules could also be implemented in hardware, either as integrated circuitry or burned into read-only memory components. The various implementations of the source code and object and byte codes can be held on a computer-readable storage medium, such as a floppy disk, hard drive, digital video disk (DVD), random access memory (RAM), read-only memory (ROM) and similar storage mediums. Other types of modules and module functions are possible, as well as other physical hardware components.

By recognizing and analyzing people, objects, and scenes present in the social networking images 14 posted by the member, the member's personality can be evaluated and monitored. FIG. 2 is flow diagram showing a computer-implemented method 20 for personality analysis based on social network images in accordance with one embodiment. The method 20 can be implemented by a system 10 of FIG. 1. Initially, images 14 posted by a member of social networking site 13 on one or more pages of that site 13 are accessed by the server 11, such as by connecting to the social networking sites 13 over the Internetwork 12 and downloading the images 14 posted by the member to a database 17. In one embodiment, all of the images 14 posted by the member on a social network 13 are accessed. In a further embodiment, only the images 14 posted within the predefined time interval, such as the previous month, week, or day are accessed. Other time periods are possible. In a still further embodiment, the server 11 accesses images 14 posted by the same individual on multiple social networking sites 13 of which the individual is a member, accessing either all of the images 14 available or only images 14 posted within a predefined time period.

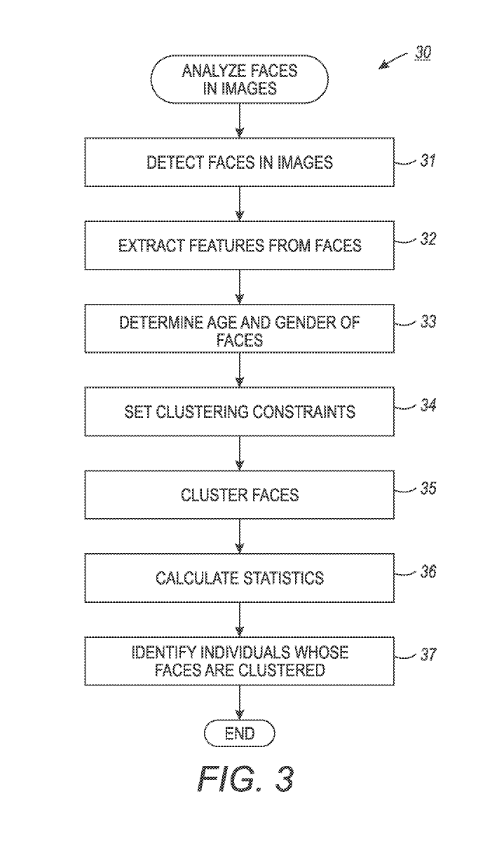

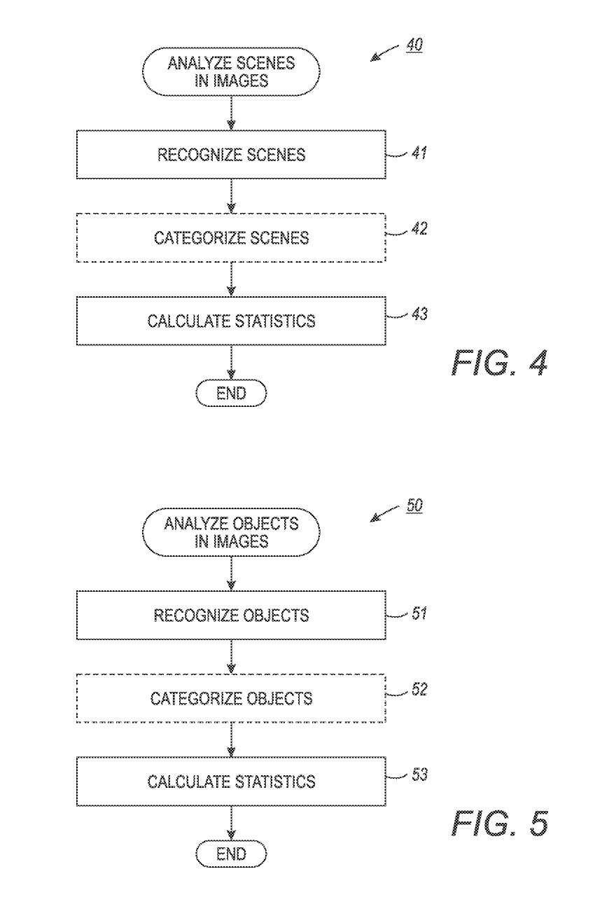

After the images are accessed, the images 14 are analyzed (step 22), as further described with reference to FIGS. 3, 4, and 5. The analysis can involves analyzing one or more attributes of the images 14. For example, the analysis can include analyzing one or more of faces in the images 14, analyzing scenes in the images 14, and analyzing objects in the images 14. The analysis of faces in the images 14 is further described below with reference to FIG. 3. The analysis of the scenes is further described below with reference to FIG. 4.

The analysis of the objects is further described below with reference to FIG. 5.

Based on the analysis of the images 14, the personality of the member who posted the images is evaluated, as further described below with the reference to FIG. 6 (step 23). The results of the analysis are output to a user of the system 10, such as on a display connected to the server 11 (step 24). If the system 10 is tasked with only evaluating the member's personality at a single point of time and detecting changes in the member's personality is not necessary (step 25), the method 20 ends. If the system 10 is tasked with detecting changes in the member's personality over time (step 25), the system 10 determines whether enough data has been generated for the detection of the changes (step 26). In one embodiment, the system 10 has enough data when evaluations of the member's personality based on the images 14 posted during at least two different time intervals have been conducted. For example, such evaluations could have been conducted based on images 14 posted by the member on a social network 13 at different months. In a further embodiment, personality assessments based on images 14 posted at more than two different time periods may be necessary for the detection. If not enough data has been collected for the detection (step 26), the method 20 returns to step 21 and an additional evaluation based on the images 14 that have not previously been analyzed is performed as described above with reference to steps 21 through 23. If enough data has been elected (step 26), the data is analyzed to detect a change of the personality of the social network member over time (step 27). In one embodiment, the analysis can involve comparing evaluations generated based on images 14 posted by the social network member at different time intervals and detecting the differences between the evaluations. For example, if the system 10 uses the Big Five model, a change in the score for one or more of the five factors can be identified as a change in the member's personality by the system 10. In a further embodiment, any differences calculated between the scores for the same factors can be compared to a threshold and be considered a change only if they satisfy the threshold. For example, one evaluation can be conducted based on images 14 posted when the member was known to be doing fine. By comparing this evaluation to an evaluation performed based on images 14 posted at a different time interval, the system 10 can detect a change that could potentially be indicative of a worsening of the member's psychological health.

In a still further embodiment, the system 10 can determine an approximate time when the member's personality experiences a change. As described below, the analysis of the images 14 can produce statistics regarding people, scenes, and objects present in the images 14. A probability distribution of these statistics can be associated with a set of personality traits. Comparing two such distributions, obtained by analyzing multiple sets of images 14, the sets having been posted at different times, can indicate whether or not the subject's personality has changed. Finding a point in time such that the distribution of statistics before that point is substantially different from the distribution of statistics after that point allows determining the approximate time a change in personality has occurred. This information can be used for monitoring for malicious insiders as well as other purposes.

Any detected changes are output to a user of the system 10 (step 28), ending the method 20. Output can include displaying the changes to a user of the system and sending a message to the user of the system. For example, a message can be sent to the user when a change in a personality is detected. Other ways to alert the user of the system 10 to a change in the personality of the member are possible. Other ways to output the data are possible.

Analyzing the faces present in the images 14 allows to obtain information regarding individuals that a member of a social network spends time with, which can provide clues to the member's personality. For example, a lot of different individuals appearing in the images 14 can be a clue towards the member' extraversion, while a small number or a complete absence of people in the images can be a clue towards the member's introversion. FIG. 3 is a flow diagram showing a routine 30 for analyzing faces in the images for use in the method 20 of FIG. 2 in accordance with one embodiment. Initially, faces are detected in the images and extracted from the images (step 31). The detection can be done using techniques such as described in P. Viola and M. Jones, “Robust real-time face detection,” International Journal of Computer Vision, vol. 57, no. 2, pp. 137-154, 2004, the disclosure of which is incorporated by reference. Alternatively, the faces can be detected using the techniques described by A. Pentland, D. Moghaddam, T. Starner, “View-based and modular eigenspaces for face recognition,”Proc. IEEE Conf Computer Vision and Pattern Recognition, 1994, pp. 84-91, the disclosure of which is incorporated by reference.

Once the faces are detected, features of the faces are extracted (step 32) using techniques such as described by N. Dalal and B. Triggs, “Histograms of oriented gradients for human detection,” International Conference on Computer

Vision and Pattern Recognition, pp. 886-893, 2005, and D. G. Lowe, “Distinctive Image Features from Scale-Invariant Keypoints,” International Journal of Computer Vision, 60(2), pp. 91-110, the disclosures of which are incorporated by reference. The extracted features can describe the whole face, or local regions around fiducial points on the faces (such as eyes, nose, mouth, and chin), or regions around automatically determined ‘interest points’ (see e.g. D. G. Lowe, “Distinctive Image Features from Scale-Invariant Keypoints,” International Journal of Computer Vision, 60(2), pp. 91-110). Such techniques allow recognizing facial features regardless of the pose and expression of the individual whose facial features are extracted as well as the lighting present in the images 14. Other ways to detect and extract the faces of individuals from the images 14 are possible.

In addition to extracting features from the faces, age and gender of faces are extracted, and consequently, of the individuals whose faces have been extracted, are determined (step 33). The age and gender of the individuals can be determined using a supervised machine learning algorithm that was previously trained on training images. Other ways to determine the age and gender of the individuals, and the faces, are possible.

Constraints for the clustering of the images are also set (step 34). The constraints include a prohibition on putting two faces appearing in the same image 14 from being clustered into the same cluster. A match between the age and gender of the faces being clustered can also be used as another constraint. As age and gender determination may be prone to error, in one embodiment, the age and gender are used as a soft clustering constraint; an exact match between the age and gender of the faces may not be required for faces to be put in the same cluster. In a further embodiment, a match between the age and gender may be required for faces to be in the same cluster. In addition, if there is prior information regarding the face and gender of a particular individual whose face has been extracted, the information can be used as a constraint instead of the determined age and gender. For example, if a particular face can be associated with an owner of a social networking profile, such as through a tag present on the image 14, and the profile has the age and gender of the owner, the age and gender from the profile can be used instead of the determined age and gender. Such use of prior information, also known as priors, as a clustering constraint allows to minimize the age and gender variation between faces in the same cluster. Other constraints are possible.

Once the constraints are set, the faces are clustered based on the similarity of the extracted features for each of the faces and the clustering constraints (step 35). The clusters can be using built using a probability distribution, such as a Gaussian or a t-distribution, using techniques such as described by M. Andreetto, L. Zelnik-Manor, and P. Perona et al., “Non-Parametric Probabilistic Image Segmentation,” ICCV, 2007, and G. J. McLachlan and K. E. Basford. “Mixture Models: Inference and Applications to Clustering,” Marcel Dekker, Inc., 1988. SERIES: statistics: textbooks and monographs, volume 84, the disclosures of which are incorporated by reference. Other clustering techniques can also be used. For example, k-means clustering can be used to generate the clusters of faces. In one embodiment, all features are given equal weight during the clustering. In a further embodiment, some features may be weighted more heavily than others during the clustering. The clustering process further uses an additional background uniform probability distribution to filter out outliers, non-face images, from the clusters, as described in the Andreeto et al. reference cited above. At the end of the clustering process, each cluster should have faces associated with the same individual, with an individual being associated with a single cluster.

Statistics for each cluster is calculated (step 36). Such statistics can include the count of faces in each cluster and the total number of clusters, which corresponds to the number of individuals in the images 14. As an individual's face can appear only once in a single image 14, the count of faces in a cluster equals to the number of images 14 in which an individual associated with the cluster appears. Based on the number of faces in the cluster, a frequency of appearance of an individual associated with the clusters can also be calculated, by comparing the number of images 14 in which the individual appears to a total number of images 14 evaluated. Still other statistics for the clusters can be calculated.

Once the statistics are calculated, the server 11 deduces information about the individuals in the images 14 (step 37), ending the routine 30. For example, the server 11 can deduce which of the individuals associated with the faces in the clusters is the member who posted the images 14 and the relationships, or connections, between the member and individuals associated with other clusters (step 37). The deductions can be based on factors such as the statistics for the clusters and any data known about the member who posted the images 14 and individuals associated with the member. For example, if the age and gender of the member are known, either from the social networking profile of the member or from another source, the age and gender of the member can be compared to the age and gender of individuals associated with the clusters. A cluster with the greatest count of faces and an age and gender of faces matching the age and gender of the member, or having age within a predefined limit of the member's age, can be deduced to be associated with the member who posted the social networking images 14. Similarly, an individual with a gender opposite to the gender of the member, whose age is either the same or within a predefined limit of the age of the member, and with the frequency of appearance among individuals of that age and gender, can be deduced as a significant other of the member, such as a spouse. Likewise, an individual who is younger than the member and who appears in the images 14 with a frequency that satisfies a predefined threshold can be deduced as a child of the member.

In a further embodiment, one of the individuals in the images 14 can be deduced to be the member based on deductions regarding other individuals. For example, if one of the individuals in the images 14 has been deduced to be the member's spouse, an individual of the opposite gender with an age matching, or being within a predefined limit, of the age of the member, and appearing in the same images 14 as the spouse more frequently than other individuals of a similar age and the same gender, can be deduced to be the member.

While an exact relationship between the member and other individuals appearing in the images 14 may not always be possible to determine, the frequency of appearance of the individuals in the images 14 can indicate the importance of the individuals to the member. Thus, if an individual associated with one of the clusters appears in the images 14 with a frequency, or another statistic, satisfying a predefined threshold, the individual can be marked as an important individual to the member.

In a further embodiment, the scenes in which the individuals appear, which are recognized as further described below, can be used to deduce the connections between the member and the important individuals. For example, if an important individual appears mostly in an office scene, the individual can be identified as a coworker. Similarly, if an individual appears mostly at a social scene, such a pub or a restaurant, the important individual can be identified as a friend.

In a still further embodiment, information present either in the images or the metadata associated with the images can be used to deduce which of the individuals is the member and the connections between the member and other individuals. For example, if individuals appearing in the images 14 are tagged with names, the tags can be compared to information known about the member, such as through the member's profiles, to identify the individuals. For example, if the social networking profile of the member lists certain individuals as close friends, the individuals identified by the tags can be deduced to be close friends of the member. Other ways to deduce which of the individuals is the member and the connections between the member and other individuals are possible. Scenes appearing in the images 14 can also provide important information regarding the social network member's personality. FIG. 4 is flow diagram showing a routine 40 for analyzing scenes present in the images 14 for use in the method 20 of FIG. 2 in accordance with one embodiment. Initially, scenes are recognized in the images 14 (step 41). The recognition of the scenes can be performed by techniques such as described in Quattoni et al., “Recognizing Indoor Scenes,” CVPR, pp 412-420, 2009, and Bart, Evgeniy, Ian Porteous, Pietro Perona, and Max Welling. “Unsupervised learning of visual taxonomies.” In Computer Vision and Pattern Recognition, 2008. CVPR 2008. IEEE Conference on, pp. 1-8. IEEE, 2008.the disclosures of which are incorporated by references. Other techniques for scene recognition can also be used.

Optionally, the recognized scenes can be categorized by type (step 42). For example, the scenes can be categorized as indoor scenes, such as an office or a home, or and outdoor scenes, such as a mountain or a river. Other types of scenes can also be present. Finally, one or more statistics is generated for the scenes, and optionally, type of scenes, recognized in the images 14 (step 43), ending the routine 40. For example, such statistics can include the count of different scenes present in the analyzed images 14, the number of times each scene appears in the images 14, the types of scenes present in the images 14, and the number of scenes for each of the types present in the images 14. The counts can also be expressed as a frequency of appearance of a scene or a type of scene in the images 14 by comparing the counts to the total number of images 14. Other statistics can be calculated.

In one embodiment, the scenes can be recognized based on the kinds of objects that appear in the images 14, as described above by Quattoni et al. In a further embodiment, the objects appearing can be used to evaluate the personality of the member directly. FIG. 5 is a flow diagram showing a routine 50 for analyzing objects present in the images 14 for use in the method 20 of FIG. 2 in accordance with one embodiment. Objects are recognized in the images 14 (step 51). The objects can be recognized using techniques such as described in Quattoni et al., “Recognizing Indoor Scenes,” cited supra, and Nair, Vinod, and Geoffrey E. Hinton. “3D Object Recognition with Deep Belief Nets.” In NIPS, pp. 1339-1347. 2009, the disclosures of which are incorporated by reference, though other techniques can also be used for object recognition. Optionally, the objects can be categorized by types of objects, such as whether the objects relate to a particular scene (step 52). Finally, statistics regarding the objects is calculated (step 53), ending the routine 50. The statistics can include a count of times each of the recognized objects appears in the images 14, the frequency 14 of appearance of the recognized object in the images 14, a count of the types of objects in the images, the count of objects for each of the types, and the frequency of appearance for each of the types. Other statistics can also be generated.

Using a supervised machine learning classifier that has previously trained on social networking images 14 allows to utilize the results of analysis of the images 14 to evaluate a personality of the social network member. FIG. 6 is a flow diagram showing a routine 60 for evaluating personality of a social network member by a supervised machine learning classifier based on analyzed images 14 for use in the method 20 of FIG. 2 in accordance with one embodiment. Initially, the system 10 inquires whether the personality classifier program 16, which includes a supervised machine learning classifier, has been trained (step 61). If the personality classifier has been trained (step 61), the routine 60 moves to step 65 below). If the classifier has not been trained (step 61), the system 10 receives training data (step 62). The training data includes a collection of social network images 14 posted by a plurality of training subjects and surveys filled out by these subjects. The subjects can be individuals who volunteered to answer the surveys and provided access to their pages on social networking sites 13. The surveys include questions answers to which are necessary to evaluate the subject's personalities in accordance with the same personality model based on which the personality of the social networking member is evaluated. Such surveys can include questions on the subjects' preferences, whether the subjects have a family such as a spouse and children, how strongly the subjects are attached to the family, how often the subjects go to bars and pubs, how often the subjects hike, whether the subjects feel comfortable speaking in public, whether the subjects consider themselves to be introverts or extroverts, and how agreeable the subjects. Other kinds of questions are also possible to be included in the survey. In a further embodiment, the training data can include results of an evaluations of the personalities of the subjects, which can be generated before the start of the method 20. The training data is processed by the server 11 (step 63), which includes analyzing the images 14 in the training data as described above with reference to FIGS. 2, 3, 4, and 5 and analyzing the surveys to generate evaluations of the personalities of the subjects. For example, if the subjects' personalities are assessed based on the Big Five model, the analysis of the surveys can include calculating a score for each of the five traits described above based on the answers. In a further embodiment, if the training data already includes personality evaluations, only the collection of the images of the subjects is analyzed. Information produced by the analysis of the images, such as statistics regarding individuals, scenes, and objects in the images, and the evaluations of the personalities are used to train a supervised, partially supervised, or unsupervised machine learning algorithm(step 64). For example, an algorithm called ‘Support Vector Regression’ described by Drucker, Harris, Chris J C Burges, Linda Kaufman, Alex Smola, and Vladimir Vapnik. “Support vector regression machines.” Advances in neural information processing systems 9 (1997): 155-161, MIT Press. the disclosure of which is incorporated by reference, can infer a mathematical function that describes a relationship between the statistics and the personality traits of the subjects based on the processed training data. Other ways to train machine learning algorithm are possible. The trained algorithm is used to evaluate the personality of the member based on the results of the analysis of the images 14 in accordance with a selected personality model (step 65), ending the routine 60. For example, the inferred function can be applied to the results of the analysis of the images 14 posted by the member, such as the statistics for the member and other individuals appearing in the images 14 for whom a connection to the member has been deduced, and statistics for scenes and objects appearing in the images 14. The applied function can be used to predict the personality traits of the member. Thus, for example, if the Big Five model is used for the evaluation of the member's personality, the result of this routine 60 can include scores for each of the five factors for the member that were derived based on the results of the analysis of the images 14 posted by the member.

While the invention has been particularly shown and described as referenced to the embodiments thereof, those skilled in the art will understand that the foregoing and other changes in form and detail may be made therein without departing from the spirit and scope of the invention.

What is claimed is:

1. A computer-implemented system for personality analysis based on social network images, comprising:
a processor configured to execute code, comprising:
an access module configured to access a plurality of images posted to one or more social networking sites by a member of these sites;
an analysis module configured to perform an analysis of the images; and
an evaluation module configured to evaluate a personality of the member based on the analysis of the images.

2. A system according to claim 1, further comprising one or more of:
a detection module configured to detect faces of individuals in the images;
an extraction module configured to extract features from the faces;
a determination module configured to determine an age and a gender of individuals associated with the faces;
a constraint module configured to set one or more constraints for clustering of the faces;
a clustering module configured to cluster the faces into one or more clusters based on the extracted features and the clustering constraints, each of the clusters comprising the faces associated with the same one of the individuals; and
a calculation module configured to calculate one or more statistics for each of the clusters.

3. A system according to claim 2, further comprising:
a data module configured to obtain data regarding the member;
a deduction module configured to deduce information regarding one or more of the individuals in the images based on at least one of the data, the statistics, and the age and the gender of the individuals, comprising at least one of:
a member module configured to deduce which of the individuals is the member;
a connection module configured to deduce a connection between at least one of the individuals and the member,
wherein the personality is evaluated based on at least one of the statistics and the deduced information.

4. A system according to claim 2, wherein the clustering constraints comprise at least one of a prohibition on clustering two faces detected in the same one of the images into the same one of the clusters and a requirement for a match of the age and gender between the faces in the same one of the clusters.

5. A system according to claim 1, further comprising at least one of:
a recognition module configured to recognize one or more scenes in the images;
a type module configured to categorize the scenes into one or more types; and
a statistic module configured to calculate one or more statistics for at least one of the recognized scenes and the types of the scenes,
wherein the personality is evaluated based on the statistics.

6. A system according to claim 1, further comprising at least one of:
a recognition module configured to recognize objects in the images;
a type module configured to categorize the objects into one or more types; and
a statistic module configured to calculate one or more statistics for at least one of the recognized objects and the types of the objects,
wherein the personality is evaluated based on the statistics.

7. A system according to claim 1, further comprising:
a receipt module configured to receive training data comprising images associated with one or more training subjects and personality data associated with the subjects;
a processing module configured to process the training data;
a training module configured to train a supervised machine learning algorithm on the processed training data; and
an algorithm module to use the trained algorithm to perform the evaluation.

8. A system according to claim 7, wherein the personality data comprises surveys completed by the training subjects.

9. A system according to claim 1, further comprising:
an additional image module configured to access additional images posted by the member on the one or more social networks;
a performance module configured to perform an analysis of the additional images;
an additional evaluation module configured to perform an additional evaluation of the personality of the member based on the analysis of the additional images; and
a comparison module configured to compare the evaluation with the additional evaluation and detecting a change in the personality of the member based on the assessment,
wherein the images are associated with a time interval and the additional images are associated with a different time interval.

10. A system according to claim 1, further comprising:
an alert module configured to alert a user to a change in the member's personality.

11. A computer-implemented method for personality analysis based on social network images, comprising the steps of:
accessing a plurality of images posted to one or more social networking sites by a member of these sites;
performing an analysis of the images; and
evaluating a personality of the member based on the analysis of the images,
wherein the steps are performed on a suitably programmed computer.

12. A method according to claim 11, further comprising one or more of:
detecting faces of individuals in the images;
extracting features from the faces;
determining an age and a gender of individuals associated with the faces;
setting one or more constraints for clustering of the faces;
clustering the faces into one or more clusters based on the extracted features and the clustering constraints, each of the clusters comprising the faces associated with the same one of the individuals; and
calculating one or more statistics for each of the clusters.

13. A method according to claim 12, further comprising:
obtaining data regarding the member;
deducing information regarding one or more of the individuals in the images based on at least one of the data, the statistics, and the age and the gender of the individuals, comprising at least one of:
deducing which of the individuals is the member;
deducing a connection between at least one of the individuals and the member,
wherein the personality is evaluated based on at least one of the statistics and the deduced information.

14. A method according to claim 12, wherein the clustering constraints comprise at least one of a prohibition on clustering two faces detected in the same one of the images into the same one of the clusters and a requirement for a match of the age and gender between the faces in the same one of the clusters.

15. A method according to claim 11, further comprising at least one of:
recognizing one or more scenes in the images;
categorizing the scenes into one or more types; and
calculating one or more statistics for at least one of the recognized scenes and the types of the scenes,
wherein the personality is evaluated based on the statistics.

16. A method according to claim 11, further comprising at least one of:
recognizing one or more objects in the images;
categorizing the objects into one or more types; and
calculating one or more statistics for at least one of the recognized objects and the types of the objects,
wherein the personality is evaluated based on the statistics.

17. A method according to claim 11, further comprising:
receiving training data comprising images associated with one or more training subjects and personality data associated with the subjects;
processing the training data;
training a supervised machine learning algorithm on the processed training data; and
using the trained algorithm to perform the evaluation.

18. A method according to claim 17, wherein the personality data comprises surveys completed by the training subjects.

19. A method according to claim 11, further comprising:
accessing additional images posted by the member on the one or more social networks;
performing an analysis of the additional images;
performing an additional evaluation of the personality of the member based on the analysis of the additional images; and
comparing the evaluation with the additional evaluation and detecting a change in the personality of the member based on the assessment,
wherein the images are associated with a time interval and the additional images are associated with a different time interval.

20. A method according to claim 11, further comprising:
alerting a user to a change in the member's personality.
